(19) United States
(12) Patent Application Publication
(10) Pub. No.: US 2026/0176902 A1
(43) Pub. Date: Jun. 25, 2026

(54) APPLIANCE AND DOOR OPENING MECHANISM THEREFOR

(71) Applicants: Yin ZHI, Wilmington, DE (US); Haier US Appliance Solutions, Inc., Wilmington, DE (US)

(72) Inventors: Yin Zhi, Shanghai (CN); Xuanjun Li, Shanghai (CN); Jiayin Li, Shanghai (CN)

(21) Appl. No.: 18/711,479

(22) PCT Filed: Aug. 17, 2023
(86) PCT No.: PCT/CN2023/113575

§ 371 Date: May 17, 2024

(51) Int. Cl. E05D 7/10; E05F 5/02; F25D 23/02; F25D 23/06

(52) U.S. Cl. CPC E05D 7/1005; E05F 5/02; F25D 23/025; F25D 23/028; F25D 23/065

(57) ABSTRACT

An appliance, a door opening mechanism, and a method for door opening assistance at an appliance is provided. The appliance includes a cabinet forming an interior volume, a door rotatably attached to the cabinet to selectively allow access to the interior volume, and the door opening mechanism positioned at an assembly surface at the cabinet or the door. The door opening mechanism includes a housing affixed to the assembly surface. A sleeve into which a button is extended is positioned within the housing. A spring or damper is positioned between the button and a bottom wall within the housing. The spring or damper is configured to exert a force along an outward direction from the housing to a contact surface at the cabinet or door opposite the button.

### FIELD OF THE INVENTION

The present disclosure relates generally to home appliances, and particularly to door opening mechanisms for freezer and refrigeration appliances.

### BACKGROUND OF THE INVENTION

Users of home appliances may experience difficulty opening a cabinet door of the appliance. Magnetic force, heavy pull force, or negative pressure (e.g., a vacuum) may cause an increase in force required to open the door. Increased negative pressure may be more acute immediately after the door is closed, as the appliance begins to cool down the warmer, denser air and generates, and the seal is pressed down and deformed.

Accordingly, a home appliance addressing one or more of these issues would be beneficial and advantageous. Additionally, a door opening mechanism for a home appliance, such as a freezer and refrigeration appliance, addressing one or more of these issues would be beneficial and advantageous.

### BRIEF DESCRIPTION OF THE INVENTION

Aspects and advantages of the invention will be set forth in part in the following description, may be apparent from the description, or may be learned through practice of the invention.

An aspect of the present disclosure is directed to an appliance. The appliance includes a cabinet forming an interior volume, a door rotatably attached to the cabinet to selectively allow access to the interior volume, and a door opening mechanism positioned at an assembly surface at the cabinet or the door. The door opening mechanism includes a housing affixed to the assembly surface. A sleeve into which a button is extended is positioned within the housing. A spring or damper is positioned between the button and a bottom wall within the housing. The spring or damper is configured to exert a force along an outward direction from the housing to a contact surface at the cabinet or door opposite the button.

Another aspect of the present disclosure is directed to a method for door opening assistance at an appliance. The method includes affixing a housing at an assembly surface at a cabinet or a door of the appliance; forming a sleeve assembly including a spring or damper assembly; affixing the sleeve assembly into the housing; and protruding a contact end wall of the spring or damper assembly to depress when the door is closed. The spring or damper assembly provides a counteracting force along an outward direction opposite of a suction force of the door to the cabinet.

Still another aspect of the present disclosure is directed to a door opening mechanism for an appliance. The door opening mechanism includes a housing affixable to a cabinet or a door of the appliance; a sleeve positioned within the housing; a button extended into the sleeve; and a damper or spring positioned between the button and a bottom wall within the housing, the damper or spring configured to exert a force along an outward direction from the housing.

These and other features, aspects and advantages of the present invention will become better understood with reference to the following description and appended claims. The accompanying drawings, which are incorporated in and constitute a part of this specification, illustrate embodiments of the invention and, together with the description, serve to explain the principles of the invention.

### BRIEF DESCRIPTION OF THE DRAWINGS

A full and enabling disclosure of the present invention, including the best mode thereof, directed to one of ordinary skill in the art, is set forth in the specification, which makes reference to the appended figures.

FIG. 1 depicts a perspective view of an exemplary embodiment of an appliance including a door opening mechanism in a door open position in accordance with aspects of the present disclosure;

FIG. 2 depicts a perspective view of an exemplary embodiment of an appliance including a door opening mechanism in a door open position in accordance with aspects of the present disclosure;

FIG. 3 depicts an exploded view of an embodiment of a door opening mechanism in accordance with aspects of the present disclosure;

FIG. 4 depicts a cross sectional view of an exemplary embodiment of the door opening mechanism positioned into a surface of an appliance in accordance with aspects of the present disclosure;

FIG. 5 depicts a transparent perspective view of an exemplary embodiment of the door opening mechanism in accordance with aspects of the present disclosure;

FIG. 6 depicts a partially transparent perspective view of an exemplary embodiment of the door opening mechanism in accordance with aspects of the present disclosure;

FIG. 7 depicts a perspective view of an exemplary embodiment of an appliance in accordance with aspects of the present disclosure;

FIG. 8 depicts a perspective view of an exemplary embodiment of an appliance including a door opening mechanism in accordance with aspects of the present disclosure;

FIG. 9 depicts perspective view of an exemplary embodiment of an appliance including a door opening mechanism in a door open position in accordance with aspects of the present disclosure; and

FIG. 10 provides a flowchart outlining steps of a method for door opening assistance for an appliance in accordance with aspects of the present disclosure.

### DETAILED DESCRIPTION OF THE INVENTION

Reference now will be made in detail to embodiments of the invention, one or more examples of which are illustrated in the drawings. Each example is provided by way of explanation of the invention, not limitation of the invention. In fact, it will be apparent to those skilled in the art that various modifications and variations can be made in the present invention without departing from the scope or spirit of the invention. For instance, features illustrated or described as part of one embodiment can be used with another embodiment to yield a still further embodiment. Thus, it is intended that the present invention covers such modifications and variations as come within the scope of the appended claims and their equivalents.

As used herein, the terms “first,” “second,” and “third” may be used interchangeably to distinguish one component from another and are not intended to signify location or importance of the individual components. The terms “includes” and “including” are intended to be inclusive in a manner similar to the term “comprising.” Similarly, the term “or” is generally intended to be inclusive (i.e., “A or B” is intended to mean “A or B or both”). In addition, here and throughout the specification and claims, range limitations may be combined and/or interchanged. Such ranges are identified and include all the sub-ranges contained therein unless context or language indicates otherwise. For example, all ranges disclosed herein are inclusive of the endpoints, and the endpoints are independently combinable with each other. The singular forms “a,” “an,” and “the” include plural references unless the context clearly dictates otherwise.

Approximating language, as used herein throughout the specification and claims, may be applied to modify any quantitative representation that could permissibly vary without resulting in a change in the basic function to which it is related. Accordingly, a value modified by a term or terms, such as “generally,” “about,” “approximately,” and “substantially,” are not to be limited to the precise value specified. In at least some instances, the approximating language may correspond to the precision of an instrument for measuring the value, or the precision of the methods or machines for constructing or manufacturing the components and/or systems. For example, the approximating language may refer to being within a 10 percent margin, i.e., including values within ten percent greater or less than the stated value. In this regard, for example, when used in the context of an angle or direction, such terms include within ten degrees greater or less than the stated angle or direction, e.g., “generally vertical” includes forming an angle of up to ten degrees in any direction, e.g., clockwise or counterclockwise, with the vertical direction V.

The word “exemplary” is used herein to mean “serving as an example, instance, or illustration.” In addition, references to “an embodiment” or “one embodiment” does not necessarily refer to the same embodiment, although it may. Any implementation described herein as “exemplary” or “an embodiment” is not necessarily to be construed as preferred or advantageous over other implementations. Moreover, each example is provided by way of explanation of the invention, not limitation of the invention. In fact, it will be apparent to those skilled in the art that various modifications and variations can be made in the present invention without departing from the scope of the invention. For instance, features illustrated or described as part of one embodiment can be used with another embodiment to yield a still further embodiment. Thus, it is intended that the present invention covers such modifications and variations as come within the scope of the appended claims and their equivalents.

Embodiments of a home appliance 100 including a door opening mechanism 130 are provided herein that address one or more of the issues described herein. Embodiments provided herein may counteract forces associated with magnetic force, heavy pull force, or negative pressure (e.g., vacuum) at a door to an appliance cabinet, such as to decrease a force required to open the door. For instance, embodiments of the appliance 100 and door opening mechanism 130 provided herein may counteract the suction caused by negative pressure, a magnetic force, or a heavy pull force (e.g., heavy door) and facilitate opening of the door by reducing a door-opening force.

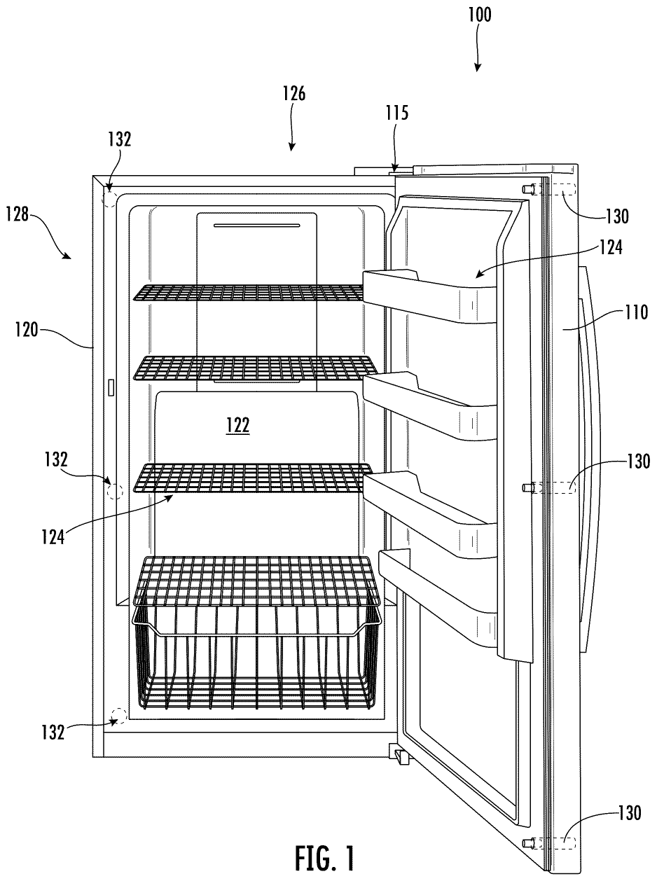

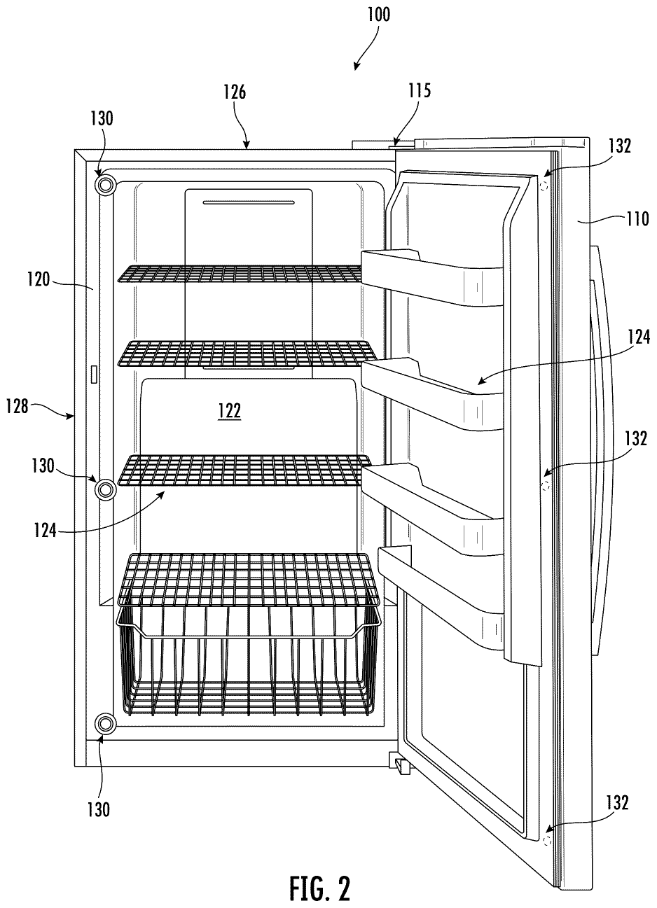

Referring now to the drawings, FIGS. 1-2 provide embodiments of the appliance 100 including exemplary locations at which the door opening mechanism 130 may be positioned. Embodiments of the appliance 100 may be configured as a freezer appliance, a refrigeration appliance, or a combination freezer-refrigeration appliance. FIGS. 1-2 depict the appliance 100 in an upright configuration. However, it should be appreciated that embodiments of the door opening mechanism 130 may be provided at home appliances forming other appliance configurations.

Embodiments of the appliance 100 generally include a cabinet 120 forming an interior volume 122 at which items may be positioned for freezing or refrigeration. Cabinet 120 is formed by a plurality of sidewalls 128. The plurality of sidewalls 128 may further include a top wall 126. A door 110 is rotatably attached to the cabinet 120 (e.g., via hinge 115) to selectively open and close to allow access to the interior volume 122. A tray or rack 124 may be positioned in the interior volume 122. For instance, the tray or rack 124 may be mounted within the cabinet 120, such as at interior faces of the sidewalls 128, or mounted at the door 110. Trays or racks 124 may be positioned at the cabinet 120 or door 110 in any desired configuration as may be generally understood for freezer or refrigeration appliances.

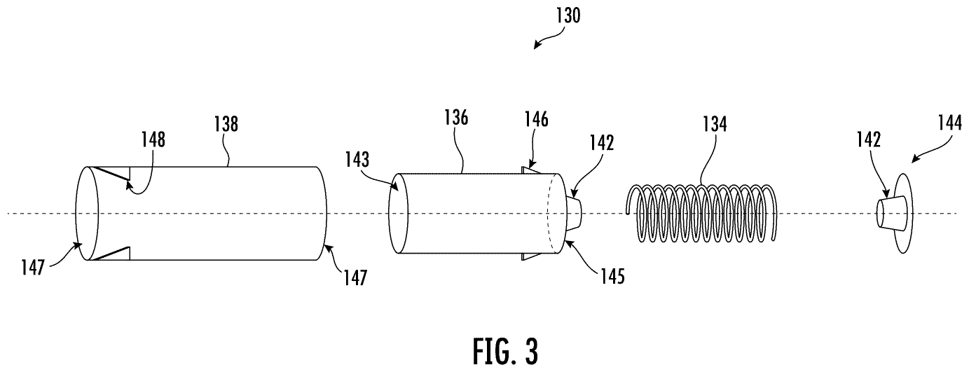

Embodiments of the door opening mechanism 130 may be positioned at the door 110 (FIG. 1), at the cabinet 120 (FIG. 2), or both. Embodiments of the door 110, the cabinet 120, or portions thereof, may be formed by a foaming process. Referring to FIG. 3, an exploded view of an exemplary embodiment of the door opening mechanism 130 is provided. Referring also to FIG. 4, a cross sectional view of an exemplary embodiment of the door opening mechanism 130 assembled into a foam substrate 106 having an assembly surface 105 of the appliance 100 is provided. The assembly surface 105 includes the door 110, the cabinet 120, or both, such as depicted in FIGS. 1-2. Referring to FIGS. 3-4, in various embodiments, the door opening mechanism 130 includes a sleeve 138 into which a button 136 is extendable. The sleeve 138 and button 136 may each form cylinders in which the button 136 has a smaller radius than the sleeve 138, such as to allow the button 136 to extend into the sleeve 138. The sleeve 138 includes open ends 147, such as to allow the button 136 to extend therethrough. The sleeve 138, the button 136, or both may include a detent 146, 148 configured to limit movement of the button 136 along a height of the sleeve 138. For instance, the button detent 146 may include a member extending from an outer surface to contact a feature at the sleeve 138. The sleeve detent 148 may include a member extending from an inner surface to contact a feature at the button 136. The detents 146, 148 may be configured to contact one another, such as at a distal end of the sleeve 138 relative to a bottom wall 144. The bottom wall 144 forms a closed end of the sleeve 138 within a housing 140.

Referring still to FIGS. 3-4, the door opening mechanism 130 may include a damper or spring 134 positioned within the sleeve 138. The damper or spring 134 is positioned between the button 136 and the bottom wall 144, such as to provide a force to push the button 136 along an outward direction, such as depicted schematically at line 160 (FIG. 4). The damper or spring 134 may be positioned between the bottom wall 144 and an end wall 145 of the button 136. For instance, the bottom wall 144 may include a snap, fit, latch, or other mechanism to selectively attach to the sleeve 138. In another instance, the bottom wall 144 may be soldered, brazed, or welded, or other method to permanently attach the bottom wall 144 to the sleeve 138. As such, the damper or spring 134 and at least a portion of the button 136 is enclosed within the sleeve 138 as an assembly. The bottom wall 144, the end wall 145, or both, may include a locating protrusion 142 around which the damper or spring 134 may be positioned, such as to guide or position the damper or spring 134 within the sleeve 138 to maximize force along the outward direction 160.

A contact end wall 143 of the button 136 is positioned distal along the height of the button 136 relative to the end wall 145. The contact end wall 143 is configured to press against a contact surface 132 (FIGS. 1-2). In some embodiments, such as depicted in FIG. 1, the contact surface 132 is positioned at the cabinet 120 opposite of the door 110 at which the door opening mechanism 130 is positioned. In still some embodiments, such as depicted in FIG. 2, the contact surface 132 is positioned at the door 110 opposite of the cabinet 120 at which the door opening mechanism 130 is positioned. It should be appreciated that, in some embodiments, the door opening mechanism 130 may be positioned at the door 110 and the cabinet 120, and accordingly, the contact surface 132 may be positioned at the door 110 and the cabinet 120 opposite of the door opening mechanism 130.

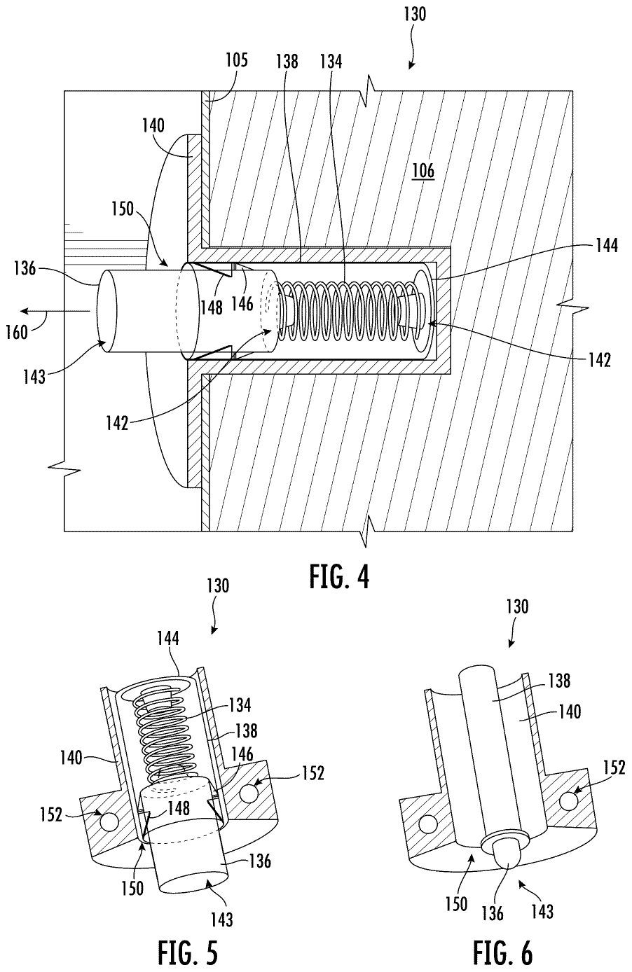

Referring now to FIG. 5, a transparent perspective view of an embodiment of the door opening mechanism 130 is provided. FIG. 6 provides a perspective view of an embodiment of the door opening mechanism 130. Referring to FIGS. 4-6, an assembly including the button 136 and the damper or spring 134 contained, at least in part, in the sleeve 138 may be positioned within the housing 140.

In some embodiments, such as depicted in FIGS. 1-3, the housing 140 may be positioned into a foam substrate at the door 110 or the cabinet 120. For instance, the foam substrate 106 may form an opening 150 into which the housing 140 is positioned. The assembly surface 105 may form a top layer or liner of the foam substrate 106. The opening 150 is formed through the substrate 106, or furthermore, through surface 105. An exemplary method for assembly may include inserting the housing 140 into the opening 150. The method may include pre-installing the housing 140 before foaming the cabinet 120 or door 110, such as to cause the housing 140 to be affixed to the cabinet 120 or door 110 after foaming. The method may further include affixing the assembly including the sleeve 138 into the housing 140 at the opening 150. Affixing the sleeve 138 may include a tight fit, interference fit, press fit, or roll-to-lock of the sleeve 138 into the housing 140 at the opening 150. In still some embodiments, affixing the sleeve 138 into the housing 140 may include providing an adhesive to the sleeve 138, the housing 140, or both, and positioning the sleeve 138 within the housing 140. Accordingly, the door opening mechanism 130 is positioned at the cabinet 120 or door 110 without requiring a mechanical fastener (e.g., screws, bolts, nuts, etc.).

In still some embodiments, such as depicted in FIG. 6, the door opening mechanism 130 may form a damper push button assembly. For instance, the damper or spring 134 may form a diaphragm or damper assembly configured to provide a counteracting force along the outward direction 160. The sleeve 138 may form a vessel configured to allow for selective capture and release of air, such as to form an air damper.

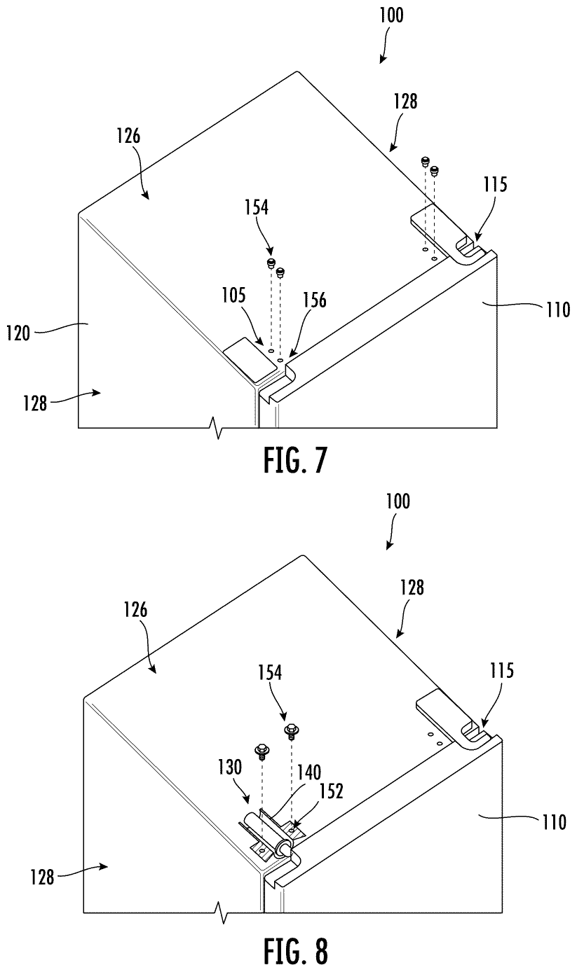

Referring to FIGS. 5-6, in some embodiments, the housing 140 may include a fastener opening 152 configured to receive a mechanical fastener 154 (FIGS. 7-8). Referring to FIGS. 7-8, perspective views of an exemplary embodiment of the appliance 100 is provided. Referring to FIGS. 5-8, in some embodiments, a method for assembly may include utilizing a fastener opening 156 extending into the cabinet 120 (e.g., at top wall 126). An embodiment of the assembly surface 105 includes the fastener opening 156, such as to attach the housing 140 to the cabinet 120 via a fastener 154 extended into the opening 156. The fastener opening 156 may correspond to an opening for receiving a mechanical fastener 154 (e.g., screws, bolts, nuts, etc.) at the cabinet 120. In various embodiments, the fastener opening 156 may include an hole or orifice formed into the cabinet 120. For instance, the fastener opening 156 may correspond to an opening for receiving the mechanical fastener 154 for attaching a hinge 115 to rotatably connect the door 110 to the cabinet 120. The cabinet 120 may include a first location or second location at which the hinge 115 is attached to the cabinet 120 and the door 110. The first location may provide for right-hand mount and opening of the door 110 and the second location may provide for left-hand mount and opening of the door 110. However, in various embodiments, the opening 156 may be positioned at any desired location along the cabinet 120 adjacent to the door 110 in the closed position, such as at the first location, the second location, or any one or more positions therebetween at the top wall 126 or along a perimeter adjacent to the door 110 in the closed position.

It should be generally appreciated in the art that only one of the first or second locations may be utilized for mounting the door 110 to the cabinet 120. Embodiments of the method for assembly may include affixing the door opening mechanism 130 to the cabinet 120 at the unused second location (i.e., the unused of the right-hand mount or left-hand mount locations). In an exemplary embodiment, fastener 154 is extendable through fastener opening 152 at housing 140 and fastener opening 156 at the cabinet 120. Embodiments of the door opening mechanism 130 and method such as provided may allow for aftermarket installation of the door opening mechanism to a home appliance, such as a freezer or refrigeration appliance, without requiring additional openings, fasteners, or integral forming at the cabinet or door. However, it should be appreciated that other embodiments of the door opening mechanism 130 and method 1000 may include forming an opening at the cabinet or door to receive the housing 140, such as via drilling or other machining process.

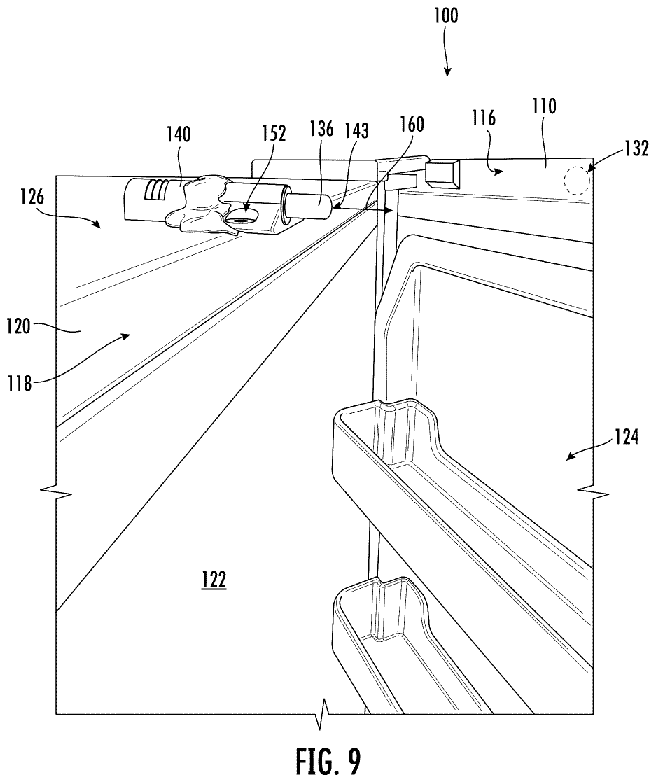

Referring to FIG. 9, a perspective view of an exemplary embodiment of the door opening mechanism 130 attached to the cabinet 120 is provided. Referring to FIGS. 4 and 9, the button 136 is positioned protruding along the outward direction 160 relative to a cabinet face 118 (FIG. 9). Referring to FIG. 9, the cabinet face 118 may generally extend parallel to an adjacent door face 116 when the door 110 is in a closed position. The door opening mechanism 130 is positioned such that, when the door 110 is closed, the button 136 is depressed. The counteracting force along the outward direction 160 works against a suction force opposite of the outward direction 160, such as to reduce a force required by a user for opening the door 110.

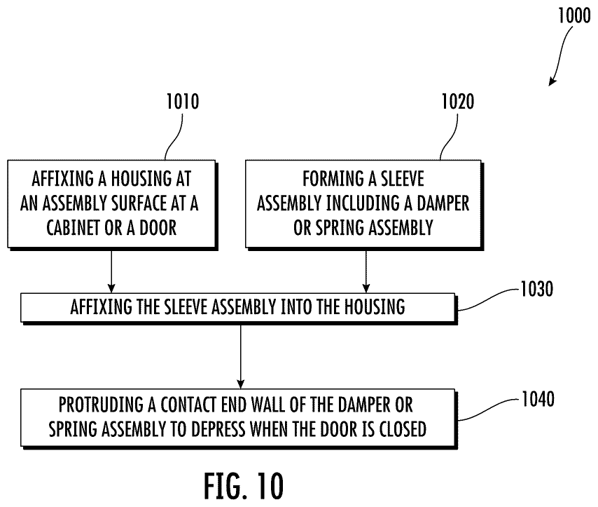

Referring now to FIG. 10, a flowchart outlining exemplary steps of a method for door opening assistance at an appliance is provided (hereinafter, “method 1000”). Embodiments of method 1000 include steps for a method for assembly of a door opening mechanism, such as described herein. Method 1000 may be performed in accordance with embodiments of the door opening mechanism 130 and appliance 100 such as depicted and described herein. However, it should be appreciated that embodiments of the method 1000 may be applied to other appliances or door opening mechanisms, such as other spring or damper mechanisms for a door opening mechanism.

Method 1000 includes at 1010 affixing a housing (e.g., housing 140) at an assembly surface at a cabinet or door of an appliance. Method 1000 at 1010 may include affixing the housing into an opening at the cabinet or door (e.g., opening 150 at cabinet 120 or door 110). Method 1000 at 1010 may include installing the housing to the opening before foaming the cabinet or door. Method 1000 includes at 1020 forming a sleeve assembly including a spring or damper assembly (e.g., sleeve 138 including button 136, damper or spring 134, and bottom wall 144). Method 1000 may include at 1030 affixing the sleeve assembly into the housing. In some embodiments, method 1000 at step 1030 occurs after steps 1010 and 1020. In still various embodiments, steps of method 1000 include methods or embodiments such as described in regard to embodiments of the door opening mechanism 130 and appliance 100 described herein.

In various embodiments, method 1000 includes a method for aftermarket installation of a door opening mechanism. In some embodiments, method 1000 at 1010 includes affixing the housing to the cabinet via an unoccupied hinge opening at the cabinet. Affixing the housing to the cabinet via the unoccupied hinge opening includes a hinge opening (e.g., opening 156) unoccupied by a hinge (e.g., hinge 115), such as described in regard to the right-hand opening or left-hand opening at which the hinge 115 may be positioned at the cabinet 120. Affixing the housing to the cabinet via the unoccupied hinge opening may include extending a fastener through the housing (e.g., via opening 152) and through a fastener opening at the cabinet (e.g., opening 156).

Method 1000 may further include at 1040 protruding a contact end wall of the spring or damper assembly (e.g., contact end wall 143 of button 136) to depress when the door is closed. For instance, method 1000 at 1040 may include positioning the contact end wall of the button to protrude the contact end wall relative to a plane extending from a cabinet face (e.g., cabinet face 118) extending parallel to an adjacent door face (e.g., door face 116) relative to the door in a closed position.

Embodiments of the door opening mechanism 130, appliance 100, and method 1000 provided herein may counteract forces associated with magnetic force, heavy pull force, or negative pressure at a door to an appliance cabinet, such as to decrease a force required to counteract the suction, weight, or magnetism and facilitate opening of the door by reducing a door-opening force.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal language of the claims.

What is claimed is:

1. An appliance, comprising:
a cabinet forming an interior volume;
a door rotatably attached to the cabinet to selectively allow access to the interior volume;
a door opening mechanism positioned at an assembly surface at the cabinet or the door, the door opening mechanism comprising a housing affixed to the assembly surface, wherein a sleeve into which a button is extended is positioned within the housing, and wherein a spring or damper is positioned between the button and a bottom wall within the housing, the spring or damper configured to exert a force along an outward direction from the housing to a contact surface at the cabinet or door opposite the button.

2. The appliance of claim 1, wherein the assembly surface is positioned at a foam substrate at the cabinet or the door, the assembly surface forming an opening into which the housing is extended.

3. The appliance of claim 1, wherein the sleeve is tight fit, interference fit, press fit, or roll-to-lock affixed to the housing.

4. The appliance of claim 1, wherein the assembly surface corresponds to a fastener opening at the cabinet, and wherein the housing comprises an opening configured to receive a fastener extended through the fastener opening at the cabinet and the housing.

5. The appliance of claim 4, the cabinet comprising a first location and a second location at which a hinge may attach the door to the cabinet via the fastener opening, wherein the door is attached to the cabinet at one of the first location or the second location, and wherein the housing is affixed to the cabinet via the fastener opening at the other of the first location or second location unoccupied by the hinge.

6. The appliance of claim 4, wherein a contact end wall of the button protrudes relative to a plane extending from a cabinet face extending parallel to a door face relative to the door in a closed position.

7. The appliance of claim 1, the sleeve and the button comprising a detent configured to limit movement of the button along a height of the sleeve.

8. The appliance of claim 1, wherein the appliance is an upright freezer or refrigeration appliance.

9. The appliance of claim 1, wherein the sleeve and the button comprises concentric cylinders at which the button is positioned at least partially within the sleeve.

10. The appliance of claim 1, wherein the bottom wall, an end wall of the button, or both, comprise a locating protrusion configured to position the spring or damper to extend along the outward direction from the housing.

11. A method for door opening assistance at an appliance, the method comprising:
affixing a housing at an assembly surface at a cabinet or a door of the appliance;
forming a sleeve assembly including a spring or damper assembly;
affixing the sleeve assembly into the housing; and
protruding a contact end wall of the spring or damper assembly to depress when the door is closed, wherein the spring or damper assembly provides a counteracting force along an outward direction opposite of a suction force of the door to the cabinet.

12. The method of claim 11, wherein affixing the housing at the assembly surface comprises affixing the housing into an opening at the cabinet or the door.

13. The method of claim 12, wherein affixing the housing into the opening at the cabinet or the door comprises installing the housing to the opening before foaming the cabinet or the door.

14. The method of claim 11, wherein forming the sleeve assembly including the spring or damper assembly comprises positioning a damper or spring between a button and a bottom wall within a sleeve.

15. The method of claim 11, wherein affixing the sleeve assembly into the housing comprises affixing via a tight fit, an interference fit, a press fit, or a roll-to-lock to the housing.

16. The method of claim 11, wherein protruding the contact end wall of the spring or damper assembly comprises positioning the contact end wall of the button to protrude relative to a plane extending from a cabinet face extending parallel to a door face relative to the door in a closed position.

17. The method of claim 11, wherein affixing the housing at the assembly surface comprises affixing the door to the cabinet via a hinge and fastener extended to a fastener location at a first location, and affixing the housing to the cabinet via the fastener location at a second location unoccupied by the hinge.

18. A door opening mechanism for an appliance, comprising:
a housing affixable to a cabinet or a door of the appliance;
a sleeve positioned within the housing;
a button extended into the sleeve;
a damper or spring positioned between the button and a bottom wall within the housing, the damper or spring configured to exert a force along an outward direction from the housing.

19. The door opening mechanism of claim 18, wherein the sleeve is tight fit, interference fit, press fit, or roll-to-lock affixed to the housing.

20. The door opening mechanism of claim 18, the sleeve and the button comprising a detent configured to limit movement of the button along a height of the sleeve.
